(19) United States
(12) Patent Application Publication
(10) Pub. No.: US 2025/0247153 A1
(43) Pub. Date: Jul. 31, 2025

(54) OPTICAL TRANSMISSION SYSTEM BASED ON LITHIUM NIOBATE MODULATOR AND ELECTRONIC DISPERSION COMPENSATION

(71) Applicant: Global Technology Inc., Ningbo (CN)

(72) Inventors: Weikang KE, Ningbo (CN); Fan YANG, Ningbo (CN); Qikun HUANG, Ningbo (CN); Yujue PAN, Ningbo (CN)

(21) Appl. No.: 18/751,965

(22) Filed: Jun. 24, 2024

(30) Foreign Application Priority Data
Jan. 25, 2024 (CN) 202410104936.2

(51) Int. Cl. H04B 10/50

(52) U.S. Cl. CPC H04B 10/503

(57) ABSTRACT

An optical transmission system includes a laser, a signal generator, a lithium niobate modulator, an optical fiber, a photodiode and an electronic dispersion compensation chip. The laser is configured to generate an initial optical signal. The signal generator is configured to generate a first electrical signal. The lithium niobate modulator is coupled to the laser and the signal generator and configured to modulate the initial optical signal with the first electrical signal generating a modulated optical signal. The optical fiber is coupled to the lithium niobate modulator with one end for transmitting the modulated optical signal. The photodiode is coupled to another end of the optical fiber for converting the modulated optical signal into a second electrical signal. The electronic dispersion compensation chip is coupled to the photodiode for compensating the electronic dispersion in the second electrical signal generating a third electrical signal.

### CROSS-REFERENCE TO RELATED APPLICATIONS

This non-provisional application claims priority under 35 U.S.C. § 119 (a) on Patent Application No(s). 202410104936.2 filed in China on Jan. 25, 2024 the entire contents of which are hereby incorporated by reference.

### BACKGROUND

### 1. Technical Field

The present disclosure relates to an optical transmission system, especially to a long-distance optical transmission system based on lithium niobate modulator.

### 2. Related Art

With the rapid development of emerging technologies such as artificial intelligence, big data, and the Internet of Things (IOT), the amount of data transmission continues to grow. In response to the rapid development of optical communication technology, the requirement for optical communication modules also becomes more and more demanding. In the terminal physical layer (remote PHY) and 5G communication network, traditional dense wavelength division multiplexing (DWDM) tunable optical modules are gradually unable to meet the requirement.

Optical modules with a data transmission rate of 10 Gbps on the market may mainly be applied to transmit data with distances of 40 kilometers and 80 kilometers. Due to the increase in data transmission volume, optical communication modules with a data transmission rate of 25 Gbps are one of the future development trends. However, optical communication modules with high transmission rates need to overcome the problem of short transmission distance.

### SUMMARY

Accordingly, the present disclosure provides an optical transmission system.

According to one or more embodiment of this disclosure, an optical transmission system includes a laser, a signal generator, a lithium niobate modulator, an optical fiber, a photodiode and an electronic dispersion compensation chip. The laser is configured to generate an initial optical signal. The signal generator is configured to generate a first electrical signal. The lithium niobate modulator is coupled to the laser and the signal generator, and the lithium niobate modulator is configured to modulate the initial optical signal with the first electrical signal to generate a modulated optical signal. The optical fiber is coupled to the lithium niobate modulator with one end for transmitting the modulated optical signal. The photodiode is coupled to another end of the optical fiber for converting the modulated optical signal into a second electrical signal. The electronic dispersion compensation chip is coupled to the photodiode for compensating electronic dispersion in the second electrical signal to generate a third electrical signal.

In view of the above structure, the optical transmission system of the present disclosure may use a lithium niobate modulator to modulate the initial optical signal with an electrical signal carrying information and to implement negative chirp modulation to the phase of the optical signal, before employing an electronic dispersion chip to compensate the optical signal. In this way, the optical pulses in the optical fiber may be compressed to improve the dispersion problem, and the dispersion accumulated during the transmission process may be compensated, so that the goal of long-distance transmission up to 40 kilometers at a data transmission rate of 25 Gbps may be achieved. Accordingly, the optical transmission system of the present disclosure may effectively increase the transmission bandwidth during the above modulation process, while reducing the modulation cost and achieving a higher modulation rate.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram of an optical transmission system according to an embodiment of the present disclosure;

FIG. 2 is a schematic diagram of a lithium niobate modulator of an optical transmission system according to an embodiment of the present disclosure; and

FIG. 3 is a functional block diagram of an optical transmission system according to another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

Due to the limitation of dispersion problems, conventional optical communication modules with a data transmission rate of 25 Gbps generally may only transmit a distance of 10 kilometers to 15 kilometers, rendering difficult meeting the requirement of longer transmission distance at higher transmission rates. Therefore, how to enable an optical communication module with a data transmission rate of 25 Gbps to transmit with a longer distance, such as 40 kilometers, is one of the problems to be solved in this field.

According to an embodiment of the present disclosure, the laser of the optical transmission system is a laser diode, specifically an adjustable laser diode with an ultra-narrow adjustable linewidth, which is a more favorable option when it comes to avoiding the dispersion compared with a large linewidth light source.

According to an embodiment of the present disclosure, the lithium niobate modulator of the optical transmission system may first adjust the phase of the optical signal to produce a pulse compression effect, realizing long-distance, high data transmission rate technology.

According to an embodiment of the present disclosure, the electronic dispersion compensation chip of the optical transmission system performs dispersion compensation or phase compensation on the electrical signal generated by the photodiode to restore the signal distortion caused by the dispersion of the optical signal experienced during the long-distance transmission in the optical fiber. Through this electronic dispersion compensation chip, the reliability of high data capacity signals during the entire transmission process may be maintained.

Some or all of the technical features disclosed in one or more embodiments of the present disclosure can be combined to achieve corresponding effects.

The term “couple” or “coupled to” refers to any connection, link, or the like. Moreover, the term “optically couple” or “optically coupled to” refers to a relationship where light is transmitted (imparted) from a device to another. Unless otherwise specified, devices that “couple” or “coupled to” each other do not need to be directly connected to each other and may be separated by intervening objects.

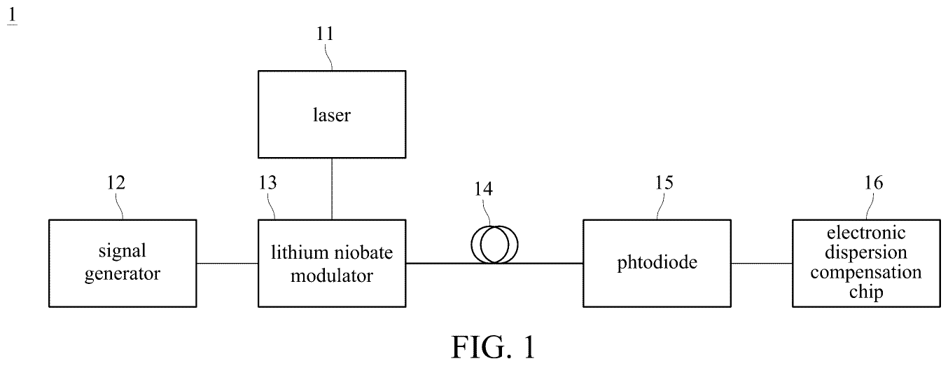

Please refer to FIG. 1, FIG. 1 is a functional block diagram of an optical transmission system according to an embodiment of the present disclosure. As shown in FIG. 1, the optical transmission system 1 includes a laser 11, a signal generator 12, a lithium niobate modulator 13, an optical fiber 14, a photodiode 15 and an electronic dispersion compensation chip 16. The laser 11 is configured to generate an initial optical signal. The signal generator 12 is configured to generate a first electrical signal. The lithium niobate modulator 13 is coupled to the laser 11 and the signal generator 12, and the lithium niobate modulator 13 is configured to modulate the initial optical signal with the first electrical signal to generate a modulated optical signal. The optical fiber 14 is coupled to the lithium niobate modulator 13 with one end for transmitting the modulated optical signal. The photodiode 15 is coupled to another end of the optical fiber 14 for converting the modulated optical signal into a second electrical signal. The electronic dispersion compensation chip 16 is coupled to the photodiode 15 for compensating the electronic dispersion in the second electrical signal to generate a third electrical signal.

In this embodiment, the laser 11 may be a laser diode, specifically an adjustable laser diode with an ultra-narrow adjustable linewidth, and its linewidth is less than or equal to 200 kHz. The electromagnetic wave wavelength of the initial optical signal generated by the laser 11 may be in infrared light, visible light, ultraviolet light or within other wavelength ranges, and the initial optical signal may be light pulses or continuous waves. The initial optical signal emitted by the laser 11 may be coupled to the input optical fiber of the lithium niobate modulator 13 through lens focusing. The signal generator 12 may be configured to generate the first electrical signal with a data transmission rate greater than or equal to 25G bps. Specifically, the signal generator 12 may be a laser diode driver (LDD), and the signal generator 12 may receive an initial electrical signal with a data transmission rate of 25 Gbps, and amplify the amplitude of the initial electrical signal to generate the first electrical signal, before transmitting the same to the lithium niobate modulator 13.

After the lithium niobate modulator 13 receives the first electrical signal and the initial optical signal, the lithium niobate modulator 13 may modulate the initial optical signal in accordance with the first electrical signal to generate a modulated optical signal carrying the information of the first electrical signal. In this way, the modulated optical signal carrying the first electrical signal information may be safely, effectively and quickly transmitted through the optical fiber. The modulated optical signal may also be converted into electrical signal for subsequent processing through other electro-optic modulators (EOM). Generally speaking, modulation may be categorized into digital modulation and analog modulation based on whether the modulated signal is a digital signal or an analog signal. Modulation methods may include amplitude modulation (AM), frequency modulation (FM), phase modulation (PM), quadrature amplitude modulation (QAM) or pulse width modulation (PWM), etc. Different modulation methods may be applied with the same modulation effect. For example, the phase modulation method may be applied to generate constructive interference with the effect of amplitude modulation. Thus, the scope of the present disclosure is not limited to various modulation methods.

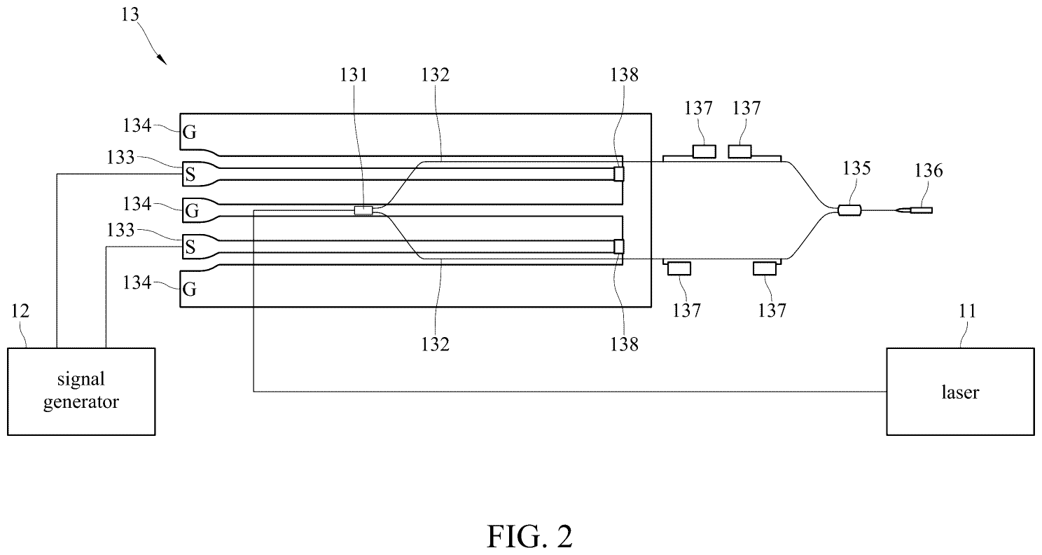

Regarding the internal structure of the lithium niobate modulator 13, please refer to FIG. 2 along with FIG. 1. FIG. 2 is a schematic diagram of the lithium niobate modulator of the optical transmission system according to an embodiment of the present invention. As shown in FIG. 2, lithium niobate modulator 13 includes an input optical fiber, an optical splitting element 131, two optical splitting paths 132, two radio frequency signal channels 133, three ground channels 134, an optical combining element 135 and an output optical fiber connector 136. The input optical fiber may be configured to receive the initial optical signal sent by laser 11. The optical splitting element 131 may be configured to split at least a part of the initial optical signal to generate two optical splitting signals. The two optical splitting paths 132 may be configured to transmit the two optical splitting signals, respectively. The radio frequency signal channel 133 may be coupled to the signal generator 12 and disposed in parallel between the two optical splitting paths 132, for transmitting the first electrical signal. The two ground channels 134 may correspond to the radio frequency signal channel 133 and may be disposed in parallel with the radio frequency signal channel 133 for the grounding purpose. The optical combining element 135 may be configured to combine the two optical splitting signals to generate the modulated optical signal. The output optical fiber connector 136 outputs the modulated optical signal. One radio frequency signal channel 133 and the two adjacent ground channels 134 may be configured to modulate one of the two optical splitting signals with the first electrical signal, while the other optical splitting signal might be modulated using another radio frequency channel 133.

In this embodiment, the lithium niobate modulator 13 is a Mach-Zehnder interferometer. Specifically, in the lithium niobate modulator 13, the initial optical signal received from the laser 11 is divided into two optical splitting signals through the optical splitting element 131 and transmitted in the two optical splitting paths 132. The radio frequency signal channel 133 disposed in parallel between the two optical splitting paths 132 may receive the radio frequency modulation signal. The radio frequency signal channel 133 is coupled to the ground channels 134 on both sides, so that there is a certain width of narrow gap between the parallel ground channels and the radio frequency signal channel. Therefore, the potential difference on both sides of the gap will generate an electric field distribution in the gap, thereby modulating the optical splitting signal in the optical splitting path 132. In addition, a terminating resistor 138 may be provided between the radio frequency signal channel 133 and the ground channel 134 as a load, when connecting to the radio frequency signal channel 133 and the ground channel 134.

In this embodiment, the lithium niobate modulator 13 may also include a set of hot electrodes 137. The hot electrodes 137 are disposed in the two optical splitting paths 132 and configured to implement phase modulation to the two split optical signals. Specifically, the hot electrode 137 may be configured to apply a direct current (DC) voltage to the two optical splitting paths 132 to modulate the phases of the two optical splitting signals. After the above modulation, the two optical splitting signals may be combined through the optical combining element 135 to generate a first modulated optical signal, which may be output through the output optical fiber connector 136. The lithium niobate modulator 13 in this embodiment may use the first electrical signal generated by the signal generator 12 to modulate the initial optical signal generated by the laser 11 through the radio frequency signal channel 133 and the ground channel 134, so as to apply the information of the first electrical signal with a data transmission rate of 25 Gbps into the optical signal. Furthermore, the lithium niobate modulator 13 may adjust the phases of the two optical splitting signals by adjusting the direct current voltage applied to the hot electrode 137.

Please continue to refer to FIG. 1 showing the modulated optical signal generated by the lithium niobate modulator 13 may be transmitted to the photodiode 15 through the optical fiber 14. In this embodiment, the length of the optical fiber 14 may be greater than or equal to 40 kilometers. Conventionally, optical signals with a data transmission rate of 25 Gbps or above will inevitably be subject to serious dispersions during such long-distance transmission, causing signal distortion and rendering challenging analyzing the original electrical signal from the final optical signal. However, through the lithium niobate modulator 13 in this embodiment, the phase of the optical signal may be adjusted first to realize pulse compression, allowing for long-distance and high-data transmission. Specifically, in the optical transmission system 1, the laser 11, the signal generator 12 and the lithium niobate modulator 13 may be disposed at the signal transmitting end, the photodiode 15 and the electronic dispersion compensation chip 16 may be disposed at the signal receiving end, and the optical fiber 14 serves as the communication connection between the signal transmitting end and the signal receiving end.

The photodiode 15 in this embodiment may be a high-gain photodiode to amplify the optical signal transmitted over a long distance and may improve the transmission sensitivity and transmission distance. Specifically, the photodiode 15 may be an avalanche photodiode (APD). The avalanche photodiode is a highly sensitive semiconductor light detector that may effectively convert optical signals into electrical signals. Compared with ordinary photodiodes, avalanche photodiodes may be applied with higher reverse voltages (>1500 volts) without breakdown. As a photodiode is subjected to a higher reverse voltage associated with a higher gain, an avalanche photodiode may have a higher gain.

The electronic dispersion compensation chip 16 may include a signal processor, a filter, etc., and is configured to phase compensate the electrical signal generated by the photodiode 15 to restore the signal distortion of the optical signal caused by the dispersion experienced during the long-distance transmission of the optical fiber 14. Through the electronic dispersion compensation chip 16, the reliability of high data capacity signals during the entire transmission process could be maintained. Specifically, taking the data transmission rate of 25 Gbps and the length of optical fiber 14 of 40 kilometers as an example, the electronic dispersion compensation chip 16 may compensate for the amount of dispersion accumulated by the optical signal propagating 30 kilometers in the optical fiber 14.

In addition to generating an electrical signal (the first electrical signal) with a data transmission rate greater than or equal to 25 Gbps, the signal generator 12 may also generate another electrical signal (the fourth electrical signal) with a data transmission rate less than 25 Gbps and greater than or equal to 10 Gbps. In this embodiment, the lithium niobate modulator 13 may further modulate the initial optical signal with a fourth electrical signal to generate another modulated optical signal (second modulated optical signal). In particular, the modulation mechanisms of the lithium niobate modulator 13 and the electronic dispersion compensation chip 16 for signals with data transmission rates of 10 Gbps and 25 Gbps may be the same or different.

In one implementation, when the lithium niobate modulator 13 receives an electrical signal with a data transmission rate of 10 Gbps, the optical signal may be modulated. In another implementation, when lithium niobate modulator 13 receives an electrical signal with a data transmission rate of 25 Gbps, the lithium niobate modulator 13 may also modulate the optical signal. Specifically, please refer to FIG. 2 together, when the radio frequency signal channel 133 of the lithium niobate modulator 13 receives an electrical signal with a data transmission rate of 10 Gbps, the hot electrode 137 may apply a direct current voltage to the optical splitting path 132 to modulate the optical signal; when the radio frequency signal channel 133 receives an electrical signal with a data transmission rate of 25 Gbps, the hot electrode 137 may also apply another direct current voltage to the optical splitting path 132 to modulate the optical signal.

Then, the electronic dispersion compensation chip 16 may selectively perform dispersion compensation or phase compensation on the electrical signal for different data transmission rates. In the above implementation, when the electronic dispersion compensation chip 16 receives an electrical signal with a data transmission rate of 10 Gbps, there may be no additional phase compensation performed on the optical signal; when the electronic dispersion compensation chip 16 receives an electrical signal with a data transmission rate of 25 Gbps, the electronic dispersion compensation chip 16 may perform phase compensation on the optical signal.

In another implementation, the lithium niobate modulator 13 may include multiple radio frequency signal channels 133, with certain radio frequency signal channels configured to transmit electrical signals with a data transmission rate of 25 Gbps and, other radio frequency signal channels configured to transmit electrical signals with a data transmission rate of 10 Gbps. In this implementation, electrical signals with one voltage swing may be applied to the radio frequency signal channel corresponding to the data transmission rate of 25 Gbps to perform phase compensation on the optical signal; electrical signals with another voltage swing may also be applied to the radio frequency signal channel corresponding to the data transmission rate of 10 Gbps to perform phase compensation on the optical signal.

The electronic dispersion compensation chip 16 may determine the amount of electronic dispersion that needs to be compensated according to the data transmission rate corresponding to the electrical signal. In one implementation, when the electronic dispersion compensation chip 16 receives an electrical signal with a data transmission rate of 10 Gbps, additional dispersion compensation may not be performed on the electrical signal; when the electronic dispersion compensation chip 16 receives an electrical signal with a data transmission rate of 25 Gbps, additional dispersion compensation may be performed on the electrical signal. Through the above-mentioned different modulation mechanisms for different data transmission rates, the optic transmission system 1 of the present disclosure may be compatible with the existing network system (10G network) at the same time, and may also be directly upgraded to a high-speed transmission network (25G network) through software in the future, so it is more flexible in use for various application needs. The different modulation mechanisms described above could be implemented as “bypassing.”

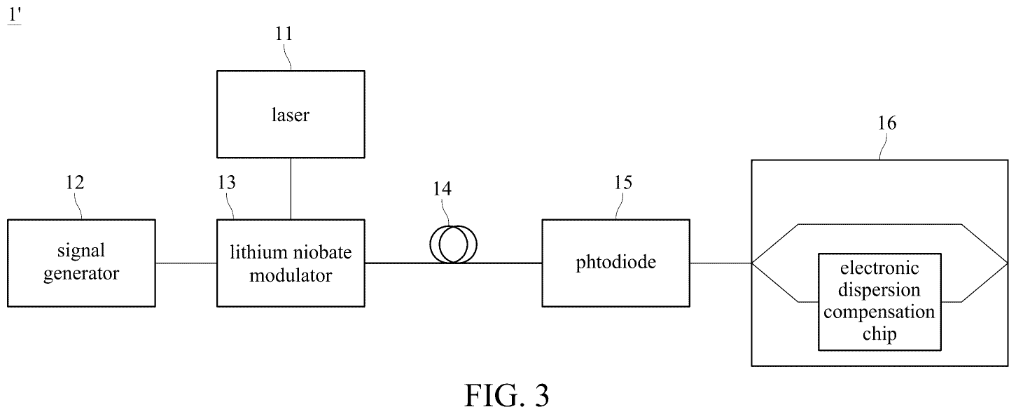

In addition to different modulation mechanisms, signals with different data transmission rates may also correspond to different transmission paths. Please refer to FIG. 3, FIG. 3 is a functional block diagram of an optical transmission system according to another embodiment of the present disclosure. As shown in FIG. 3, the laser 11, signal generator 12, lithium niobate modulator 13, optical fiber 14, photodiode 15 and electronic dispersion compensation chip 16 of the optical transmission system 1′ may be the same as the corresponding components of the embodiment in FIG. 1, and will not be described again. In this embodiment, an additional bypass signal line may be provided inside the electronic dispersion compensation chip 16.

Specifically, please refer to FIG. 2 together. When the radio frequency signal channel 133 of the lithium niobate modulator 13 receives an electrical signal with a data transmission rate of 10 Gbps, the optical signal is transmitted to the photodiode 15, with the corresponding electrical signal transmitted to the electronic dispersion compensation chip 16 and passing through the bypass signal line. In other words, the electrical signal with a data transmission rate of 10 Gbps may not undergo additional phase compensation (without being transmitted to the electronic dispersion compensation chip). On the other hand, when the radio frequency signal channel 133 receives an electrical signal with a data transmission rate of 25 Gbps, the optical signal is transmitted to the photodiode 15, with the corresponding electrical signal transmitted to the electronic dispersion compensation chip 16 without passing through the bypass signal line. In other words, the electrical signal with a data transmission rate of 25 Gbps may undergo additional phase compensation when passing through the electronic dispersion compensation chip 16. Through the above-mentioned different modulation mechanisms and different signal transmission paths for different data transmission rates, the optical transmission system 1′ in the present disclosure is more flexible in use for various application requirements.

In view of the above structure, the optical transmission system of the present disclosure may use a lithium niobate modulator to modulate the initial optical signal with an electrical signal carrying information and to implement negative chirp modulation to the phase of the optical signal, and then use an electronic dispersion chip to compensate the optical signal. In this way, the optical pulses in the optical fiber may be compressed to improve the dispersion problem, and the dispersion accumulated during the transmission process may be compensated, so that the goal of long-distance transmission up to 40 kilometers at a data transmission rate of 25 Gbps may be achieved. Accordingly, the optical transmission system of the present disclosure may effectively increase the transmission bandwidth during the above modulation process, while reducing the modulation cost and achieving a higher modulation rate. In addition, by using different modulation mechanisms for signals with different data transmission rates and switching to different signal transmission lines, the optical transmission system of the present disclosure may be more flexible for various application needs.

What is claimed is:

1. An optical transmission system, comprising:
a laser configured to generate an initial optical signal;
a signal generator configured to generate a first electrical signal;
a lithium niobate modulator coupled to the laser and the signal generator, and the lithium niobate modulator configured to modulate the initial optical signal with the first electrical signal to generate a modulated optical signal;
an optical fiber coupled to the lithium niobate modulator with one end, and the optical fiber configured to transmit the modulated optical signal;
a photodiode coupled to another end of the optical fiber, and the photodiode configured to convert the modulated optical signal into a second electrical signal; and
an electronic dispersion compensation chip coupled to the photodiode, and the electronic dispersion compensation chip configured to compensate the electronic dispersion in the second electrical signal to generate a third electrical signal.

2. The optical transmission system according to claim 1, wherein the signal generator is configured to generate the first electrical signal with a data transmission rate greater than or equal to 25 Gbps.

3. The optical transmission system according to claim 2, wherein a length of the optical fiber is greater than or equal to 40 kilometers.

4. The optical transmission system according to claim 1, wherein the laser is a laser diode and the initial optical signal has a linewidth less than 200 kHz.

5. The optical transmission system according to claim 1, wherein the photodiode is an avalanche photodiode.

6. The optical transmission system according to claim 1, wherein the modulated optical signal is a first modulated optical signal, and the signal generator is further configured to generate a fourth electrical signal, a data transmission rate of the fourth electrical signal is less than the data transmission rate of the first electrical signal, and the lithium niobate modulator is further configured to modulate the initial optical signal with the fourth electrical signal to generate a second modulated optical signal.

7. The optical transmission system according to claim 6, wherein the signal generator is configured to generate the fourth electrical signal with the data transmission rate less than 25 Gbps and greater than or equal to 10 Gbps.

8. The optical transmission system according to claim 6, wherein the electronic dispersion compensation chip is further configured to determine an amount of the electronic dispersion that needs to be compensated according to a data transmission rate corresponding to a signal.

9. The optical transmission system according to claim 8, wherein the electronic dispersion compensation chip is further configured not to implement phase compensation on the fourth electrical signal when the data transmission rate of the fourth electrical signal is less than or equal to 10 Gbps.

10. The optical transmission system according to claim 6, wherein a bypass signal line is provided inside the electronic dispersion compensation chip, and when the electronic dispersion compensation chip receives the fourth electrical signal, the electronic dispersion compensation chip switches the fourth electrical signal to pass through the bypass signal line.

11. The optical transmission system according to claim 6, wherein the lithium niobate modulator comprises:
an optical splitting element coupled to the laser, and the optical splitting element configured to split at least a part of the initial optical signal to generate two optical splitting signals;
two optical splitting paths coupled to the optical splitting element, and the two optical splitting paths configured to transmit the two optical splitting signals;
a radio frequency signal channel disposed in parallel between the two optical splitting paths, and the radio frequency signal channel configured to transmit the first electrical signal;
two ground channels disposed in parallel with the radio frequency signal channel and coupled to the radio frequency signal channel, and the two ground channels configured to be grounded; and
an optical combining element coupled to the two optical splitting paths, and the optical combining element configured to combine the two optical splitting signals and generate the modulated optical signal,
wherein, the radio frequency signal channel and the two ground channels are configured to modulate the two optical splitting signals in accordance with the first electrical signal.

12. The optical transmission system according to claim 11, wherein the lithium niobate modulator further comprises a set of hot electrodes disposed at the two optical splitting paths, and the set of hot electrodes is configured to implement phase modulation on the two optical splitting signals.

13. The optical transmission system according to claim 11, wherein the lithium niobate modulator further comprises a terminating resistor disposed between the radio frequency signal channel and the two ground channels, and the terminating resistor is coupled to the radio frequency signal channel and the two ground channels.
